(19) United States
(12) Patent Application Publication
(10) Pub. No.: US 2007/0175236 A1
(43) Pub. Date: Aug. 2, 2007

(54) PORTABLE REFRIGERATION CONTAINER

(76) Inventor: NATHAN DRYZUN, VICTORIA (AU)

Correspondence Address: MILLS OAKLEY PATENT ATTORNEY;MARTIN EARLEY AND WARREN CHANDLER, P.O. BOX 453 COLLINS STREET WEST, MELBOURNE, 8007, AU

(21) Appl. No.: 10/599,184

(22) PCT Filed: Mar. 24, 2005
(86) PCT No.: PCT/AU05/00435

§ 371 Date: Sep. 22, 2006

(30) Foreign Application Priority Data
Mar. 24, 2004 (AU) 2004901547
Jul. 15, 2004 (AU) 2004903882

(51) Int. Cl. F25D 3/08; F25D 19/00; F17C 13/00

(52) U.S. Cl. 62/371; 62/298; 62/457.9

(57) ABSTRACT

Pallet version of the portable refrigeration container including a palletised thermally insulated base (20) including seal mechanism, forklift fork receiving cavities (21) allowing ready transportability. A dismantlable wail assembly (35) comprising hinged vacuum insulated panels (35) are able to be mounted on the palletised thermally insulated base (20) and engaging with the perimeter channel (23) forming the base sealing mechanism. The thermally insulated hinge type collapsible concertina configuration of side panels (35) have latch mechanism for holding panels in rectangular configuration defining a container volume therein. A thermally insulated lid (40) covers the top of the container volume and includes a seal mechanism for engaging with the wall assembly. The portable refrigeration container includes an integral cooling system, for cooling the container volume, incorporated in one or more of the base, sides or lid.

### FIELD OF THE INVENTION

This invention relates to a portable refrigeration container. The invention particularly relates to an improved transportable refrigeration container for operation at required locations. It is more particularly directed at a portable refrigeration container that is capable of maintaining a refrigerated space temperature for several days without the need for any mains power source but is not limited to such.

### BACKGROUND ART

There is an immediate need for temporary refrigerated storage space in many situations. This can include disaster zones as seen in the recent tsunami disasters. However even in normal commercial retail industries there is a need to have refrigerated storage spaces at places remote from the normal power supply. These locations can be at sporting or artistic or social events where food preparation and food consumption is in temporary locations such as in temporarily erected marquees. This could also be at fairs, circuses, or the like where the show goes “on the road”. There is also a current shortage of refrigerated space in supermarkets, liquor & convenience stores where a portable device is an ideal solution; in particular product branding/promotions.

Current commercial refrigeration units are usually designed as permanent storage and not intended for use as portable/transportable devices. At present there is a requirement to use fixed structures which are heavy and difficult to move. Alternatively there is the use of portable refrigerated trailers or trucks. However the costs of such structures limit their use, and in particular only allow a single refrigerated trailer or truck to service a large area. This is not suitable if multiple vendors need to use refrigeration to display their wares at a temporary location.

Therefore there is a need for promotional/temporary refrigerated space to be provided for efficiently and economically (i.e. without the need for special materials handling equipment due to size/weight restraint) being transportable consuming minimal storage volume and with ease of assembly and disassembly.

There are no known refrigerated display cases of this type

### SUMMARY OF THE INVENTION

In accordance with the invention there is provided portable refrigeration container including a base, a dismantlable wall assembly able to be mounted on the base to form a container volume, and a lid assembly able to cover the top of the container volume to provide an enclosed volume, the portable refrigeration container further including a cooling means able to maintain the enclosed volume in a cooled state.

Also in accordance with the invention there is provided a portable refrigeration container including:

a palletised thermally insulated base including seal mechanism with integral battery compartments for holding a battery pack and forklift fork receiving cavities allowing ready transportability;

a dismantlable wall assembly for mounting on the palletised thermally insulated base and engaging with the base sealing mechanism and including a thermally insulated hinge type collapsible concertina configuration of side panels with latch mechanism for defining a container volume therein;

a thermally insulated lid for covering the top of the container volume and including a seal mechanism for engaging with the wall assembly; and an integral refrigeration unit, for cooling the container volume, incorporated in one or more of the base, sides or lid and powered at least partially by the battery.

The container assembly can include a connector such as a tie strap mechanism to secure lid and base to side panels and provide improved structural integrity and prevent pilferage.

The palletised collapsible refrigeration container is capable of maintaining a refrigerated space temperature for several days without the need for any external power source.

The base is a thermally insulated palletised housing with integral seal mechanism located around the upper face perimeter (channel) and designed for four way fork lift entry. The battery pack housing is integrated within the raised feet.

Hinged thermally insulated side panels with mitered (45°) corners including seal mechanism in a concertina configuration are designed to collapse and open to form a rectangular (square) shape. The horizontal top and bottom end surfaces interface and seal against the palletised base and lid mating surfaces (channels).

The lid is a thermally insulated housing with integral seal mechanism located around the lower face perimeter (channel). An integrated refrigeration housing located (moulded or fabricated) as part of the external surface contains the heat rejection side of the refrigeration module. A cold storage refrigeration coil is mounted to the lid under face. All refrigeration cycle components are in fluid communication with each other.

The refrigeration container may also be powered off any suitable power source, such as mains power 240VAC 50 Hz or 115VAC 60 Hz.

The container and thermal insulation may be manufactured (moulded or fabricated) from any suitable material, such as polymer or composites.

The seal mechanism can be manufactured (extruded) from any suitable material, such as rubber type compounds. The hinge mechanism, latch mechanism and tie strap mechanism can be manufactured from any suitable material, such as metal, polymer, composite or elastic type compounds.

This invention will contribute significant improvements in refrigeration shipping container movements. Conventional refrigeration transportation means such as the use of refrigerated truck, refrigerated rail car, refrigerated inter-model container (land) and in particular passive cooled air freight container (dry/wet ice) may no longer be necessary. Transportation means without refrigerated provisions or power source is suitable for the movement of palletised collapsible refrigeration containers.

Containers of the invention can be transported via land (railroad) loaded onto aircraft and destined for anywhere in the world maintaining cold chain integrity. The invention provides for a stackable single pallet footprint of the collapsible stand-alone refrigeration container that maximises conventional rail/road transportation dimensions, such as two abreast (maximum width) stacked two high (maximum height). This allows opportunity for reduction of cost and direct expense of moving empty containers for both domestic and international markets running into the tens of millions of dollars annually.

Therefore the advantages of shipping this type of refrigeration container include:
a). Collapsibility (several stacked containers replace shipping volume of a single empty container)
b). Stand alone power source for several days (use of non-refrigerated vehicles)
c). Super thermal insulation (Vacuum Insulation Panel) maximises refrigerated storage space
d). Lightweight, hygienic and robust structure (use of composites and polymers)
e). Container base substitutes pallet requirement (enclosure constructed around product)

This invention in another aspect relates to a collapsible refrigerated display case wherein the base is a universal base refrigeration module which can be easily configured (assembled/disassembled) as either a front load or top load display case as required for the application. The assembly is capable of maintaining a medium refrigerated space temperature (above product freezing) but not limited. A low refrigerated space temperature with alternative refrigeration component specifications including a defrost mechanism is optional.

The collapsible refrigerated display case assembly in a top load form comprises the universal base refrigeration module, a collapsible side panel assembly (rectangular), a perforated panel duct and a lid assembly.

The collapsible refrigerated display case assembly in a front load form comprises a universal base refrigeration module, a collapsible side panel assembly (rectangular), perforated panel duct, shelving, a door assembly and a lid assembly.

In the front load display case configuration the universal base refrigeration module (i.e. fabricated/moulded) is partitioned into two zones (High Temperature and Low Temperature) with airflow and ventilation paths and thermally insulated between the two. The base assembly open face is sealed by a lid (i.e. fabricated/moulded) comprising an integral seal mechanism located around the upper face perimeter (channel) and including integrated ducts/vents for return and supply air.

The base houses a vapour compression refrigeration system comprising the following components, in a high temperature zone: a compressor, a condensate drain tray with coil (to contain/evaporate water condensate and de-superheat compressor discharge vapour), a heat rejection assembly (condenser coil with fan), a filter drier, and a refrigerant control mechanism; and comprising in a low temperature zone: a heat sink assembly (evaporator coil with fan), accumulator and temperature control. All refrigeration cycle components are in fluid communication with each other (via plumbing).

Hinged thermally insulated side panels (i.e. fabricated/moulded) with mitered (i.e. 45°) corners including seal mechanism in a concertina configuration are designed to collapse and open to form a 90° angular (‘U’) shape. The horizontal top and bottom end surfaces interface and seal against the refrigeration base and lid mating surfaces (channels). The inner side walls have several parallel rails designed to support removable product display shelving. The open face inner side wall edges each have vertical square edged rails designed to interface with the door assembly side channels

A perforated panel duct (i.e. fabricated/moulded) located around the discharge air vent and rear panel inner face is designed to uniformly distribute refrigerated air. Several wire shelves are positioned as required on parallel inner panel support rails

The front load door assembly frame comprises two vertical side members with ‘U’ channels which interface (slide into) with the side panel vertical square edged rails. Top and bottom cross members (rectangular) interface with the base and lid mating surfaces (channels). A removable hinged sealed door with insulated transparent window (single/multiple air cavity) is attached to the frame to allow for product view and access.

The lid (i.e. fabricated/moulded) is a thermally insulated housing with integral seal mechanism located around the lower face perimeter (channel).

In the top load display case configuration the universal base refrigeration module (i.e. fabricated/moulded) is partitioned into two zones (high temperature and low temperature) with airflow and ventilation paths and thermally insulated between the two. The base assembly open face is sealed by a lid (i.e. fabricated/moulded) comprising an integral seal mechanism located around the upper face perimeter (channel) including integrated ducts/vents (return and supply air).

The base assembly houses a vapour compression refrigeration system comprising the following components, in the high temperature zone: a compressor, a condensate drain tray with coil (to contain/evaporate water condensate and de-superheat compressor discharge vapour), a heat rejection assembly (condenser coil with fan), a filter drier, a refrigerant control mechanism and in the Low Temperature Zone: a heat sink assembly (evaporator coil with fan), accumulator and temperature control. All refrigeration cycle components are in fluid communication with each other (via plumbing).

Hinged thermally insulated side panels (i.e. fabricated/moulded) with mitered (i.e. 45°) corners including seal mechanism in a concertina configuration are designed to collapse and open to form a rectangular shape. The horizontal top and bottom end surfaces interface and seal against the refrigeration base and lid mating surfaces (channels).

A perforated panel duct (i.e. fabricated/moulded) located around the discharge air vent and rear panel inner face is designed to uniformly distribute refrigerated air

The top load lid housing (i.e. fabricated/moulded) with integral seal mechanism located around the lower face perimeter (channel) interface with the insulated side panels. A removable hinged sealed lid (i.e. fabricated/moulded) with insulated transparent window (single/multiple air cavity) is attached to the housing to allow for product view and access.

The base refrigeration module may be powered off any suitable power source, such as Alternating Current (AC): (i.e. 240VAC 50 Hz or 115VAC 60 Hz) and Direct Current (DC): (i.e. 12 to 48VDC)

The refrigerated display case may be manufactured (i.e. fabricated/moulded) from any suitable material, such as metals, polymers or composites.

The insulation can be manufactured (i.e. moulded) from any suitable material, such as polymers or composites. The seal mechanism can be manufactured (i.e. extruded) from any suitable material, such as rubber/synthetic type compounds. The hinge mechanism and the latch mechanism can be manufactured from any suitable material, such as metal, polymer, composite or elastic type compounds. The tie strap mechanism may be manufactured from any suitable material, such as metal, polymer, composite or elastic type compounds.

The collapsible side panel assembly outer faces can have provision for advertising, such as moulded/fixed channels/grooves on outer edges as required to locate and support bill boards (i.e. printed fibreboard/plastic sheet).

The advantages of this type of refrigeration display case include:
a). High visibility advertising and marketing tool
b). Reduced Premium Costs (i.e. short term refrigerated space substituted with the utilization of standard floor space)
c). Collapsibility (i.e. utilizes maximum shipping volume, use of smaller vehicles)
d). Portability (Occupational Health and Safety issues addressed i.e. components of assembly moved at ease due to partial weight and reduced physical size)
e). Materials Handling Equipment (no need for specialized equipment)

### BRIEF DESCRIPTION OF THE DRAWINGS

In order that the invention is more readily understood embodiments of the invention will be described by reference to the drawings wherein:

FIG. 1 illustrates an assembly of portable refrigeration container in accordance with a first embodiment of the invention in the form of a palletised collapsible refrigeration container complete with hinge, latch mechanism, refrigeration module and strapping;

FIG. 2 illustrates an assembly exploded view of the palletised collapsible refrigeration container of FIG. 1 with hinged thermally insulated side panels in collapsed configuration with mitered corners, seal mechanism and palletised base with integral seal mechanism located around the upper face perimeter (channel);

FIGS. 3A, 3B, 3C and 3D show a top view, ‘air-on’ Condenser Coil view, a section A-A view of FIG. 3B, and ‘air-off’ Condenser Coil view of the palletised collapsible refrigeration container of FIG. 1 with tentative dimensions;

FIG. 4 shows a perspective view of the heat sink of FIG. 2 in the form of eutectic system to be incorporated in the lid of the palletised collapsible refrigeration container;

FIG. 5 s an exploded view of the components of the eutectic system of FIG. 4;

FIG. 6 is an plan view of the heat exchange plate component of the eutectic system of FIG. 4;

FIGS. 7A and 7B are a cross sectional view and a detail of A of FIG. 7A of the eutectic system of FIG. 4;

FIG. 8 illustrates an isometric assembly of a portable refrigeration container in accordance with a second embodiment of the invention in the form of a front load collapsible refrigerated display case;

FIGS. 9A, 9B, 9C and 9D show sectional, front, side and top view elevations including phantom views of internal components of the front load collapsible refrigerated display case of FIG. 8 with tentative external dimensions;

FIG. 10 illustrates exploded view diagram including component labels of the front load form of the collapsible refrigerated display case of FIG. 8;

FIG. 11 illustrates an isometric assembly of a portable refrigeration container in accordance with a third embodiment of the invention in the form of a top load collapsible refrigerated display case;

FIGS. 12A, 12B, 12C and 12D show sectional, front, side and top view elevations including phantom views of internal components of the top load collapsible refrigerated display case of FIG. 11 with tentative external dimensions;

FIG. 13 illustrates an exploded view of the top load collapsible refrigerated display case of FIG. 11.

### PREFERRED EMBODIMENT OF THE INVENTION

Referring to the drawings there is shown a portable refrigeration container including a base, a dismantlable wall assembly able to be mounted on the base to form a container volume, and a lid assembly able to cover the top of the container volume to provide an enclosed volume, the portable refrigeration container further including a cooling system able to maintain the enclosed volume in a cooled state.

Pallet Version

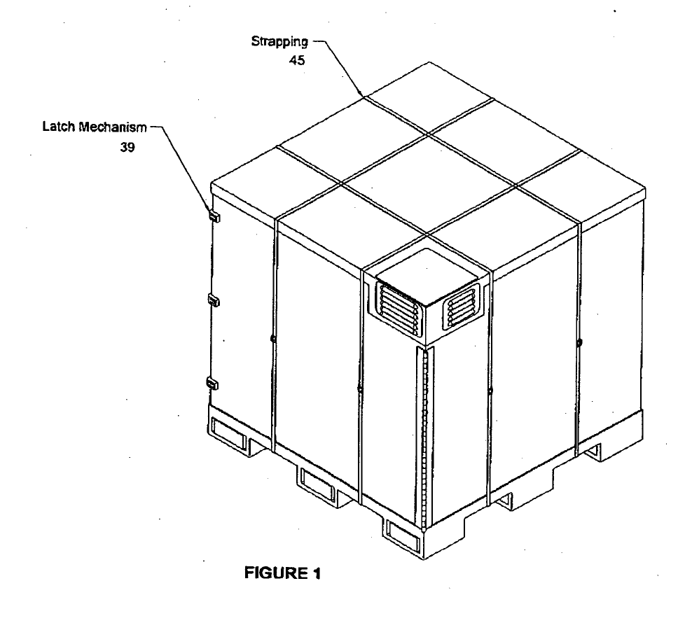

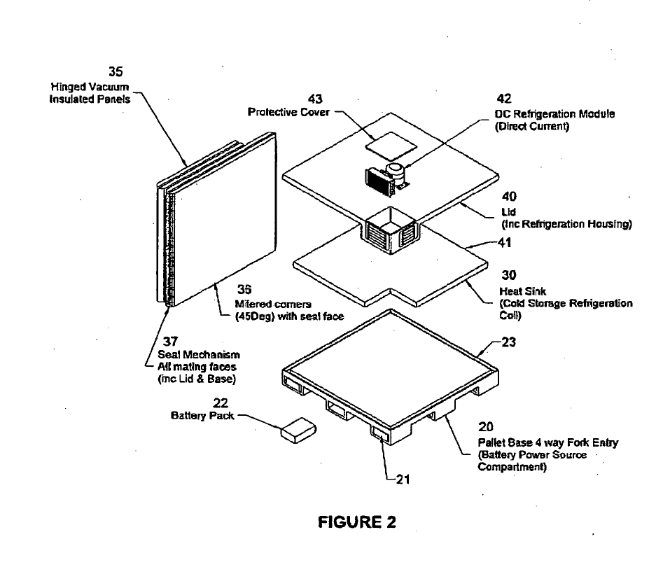

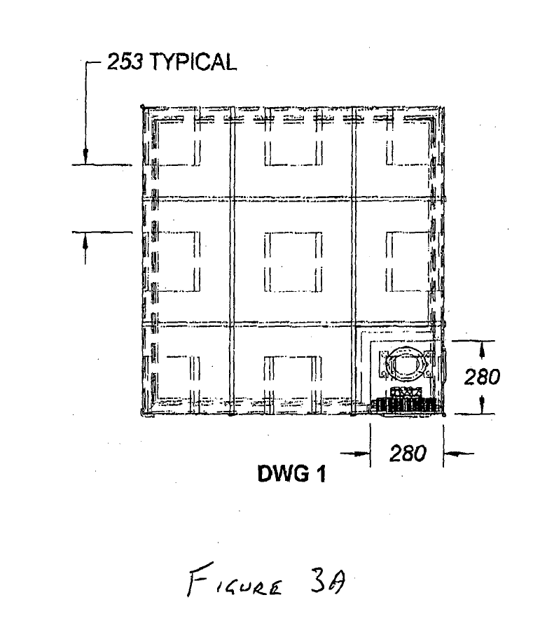

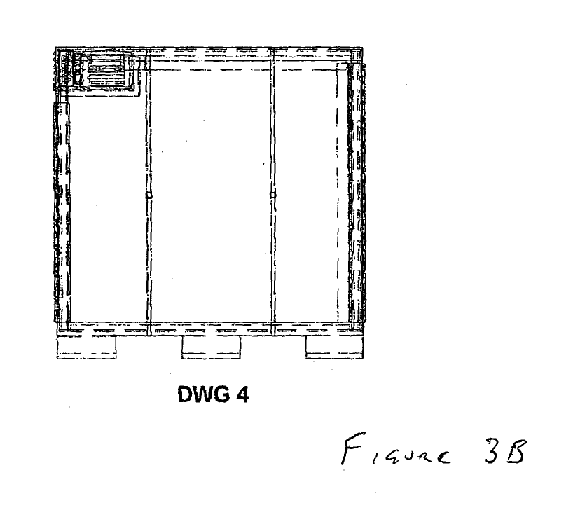

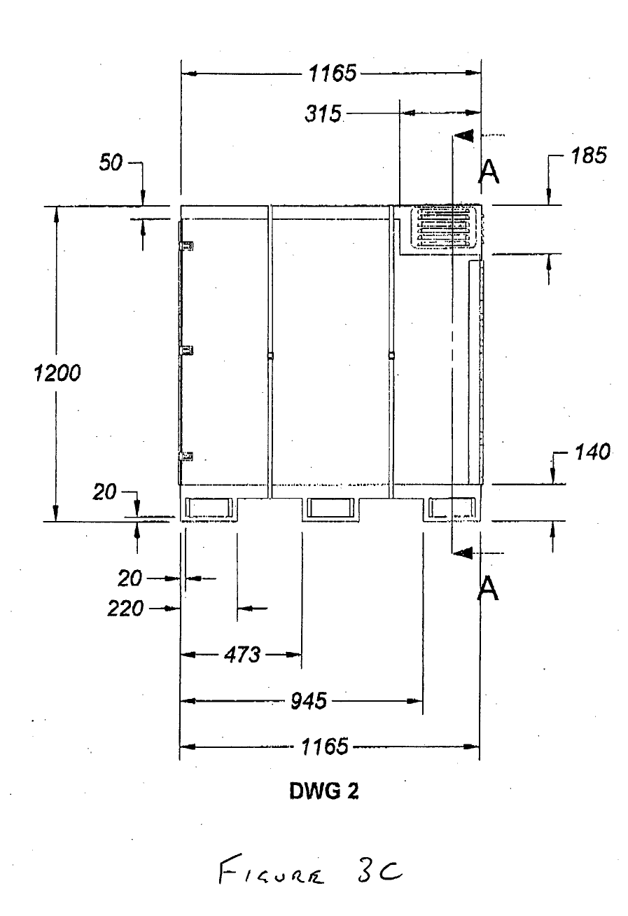

In a typical application of the pallet version of the portable refrigeration container as shown in FIGS. 1 to 3D, there is shown a portable refrigeration container including a palletised thermally insulated base 20 including seal mechanism, forklift fork receiving cavities 21 allowing ready transportability. A dismantlable wall assembly 35 comprising hinged vacuum insulated panels 35 are able to be mounted on the palletised thermally insulated base 20 and engaging with the perimeter channel 23 forming the base sealing mechanism. The thermally insulated hinge type collapsible concertina configuration of side panels 35 have latch mechanism for holding panels in rectangular configuration defining a container volume therein. A thermally insulated lid 40 covers the top of the container volume and includes a seal mechanism for engaging with the wall assembly. The portable refrigeration container includes an integral cooling system, for cooling the container volume, incorporated in one or more of the base, sides or lid.

In use the palletised container base is first loaded with refrigerated product. The collapsible concertina side wall panel assembly configuration is opened to form a rectangular shape and located around the palletised container base interfacing seal mechanism perimeter

The lid section 40 is with preconditioned cold storage refrigeration coil 30 is positioned to interface over the side panels 35 top face. The assembly is secured with latch 39 and strap mechanisms 45. A refrigeration module 42 is mounted in a corner cavity 41 of the lid 40 and covered by protective cover 43 to provide a flat top. A battery pack 22 is mounted between the feet of the pallet base 20 providing the forklift fork receiving cavities 21.

The assembly is able to be fork lifted, loaded onto the tray of a truck and road transported. The assembly is further able to be forklifted, unloaded onto a tarmac and material handled directly into an aircraft hold.

The principal of operation is that prior to refrigeration product loading the vapour compression refrigeration system is run off an external power source and the cold storage refrigeration coil is preconditioned by the removal of absorbed heat from a eutectic type solution (or any other suitable solution) until maximum cooling capacity is achieved. (Example. water ice @ 0° C. latent heat of fusion: 335 kJ/kg)

The refrigerated product is maintained at refrigeration capacity of the eutectic solution until such time that the entire phenomenon latent heat of fusion is absorbed. A cold storage refrigeration coil sensor cuts in the vapour compression refrigeration system to maintain refrigeration cooling capacity and further remove absorbed heat from the eutectic solution

In other embodiments of the invention the refrigeration cooling capacity can be maintained by either one of the above methods. By other types of refrigeration system or by the use of expendable refrigerants such as dry ice (CO₂) or water ice (H₂O).

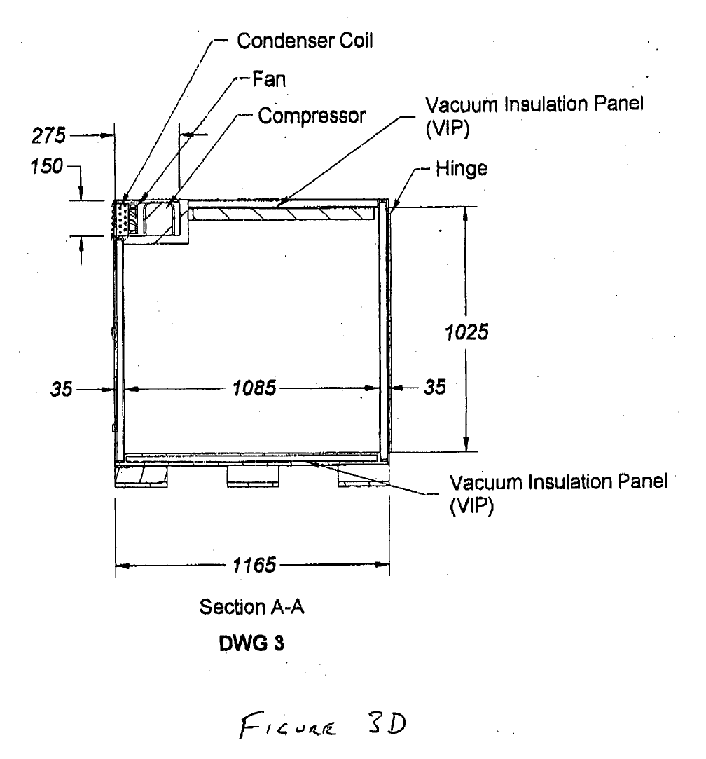

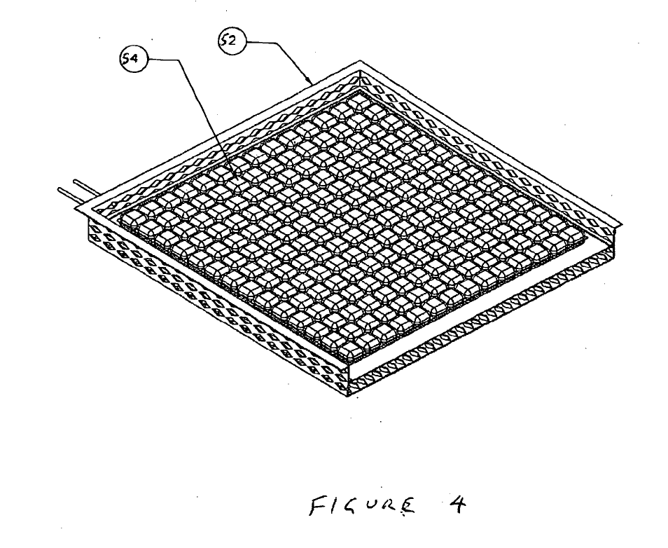

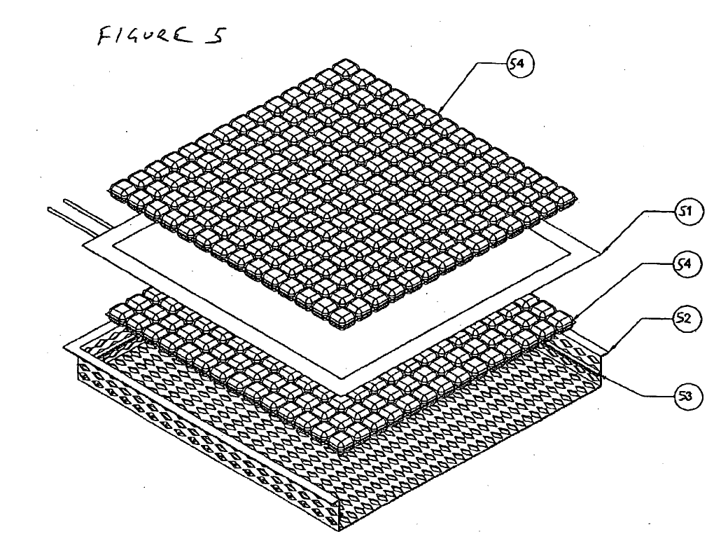

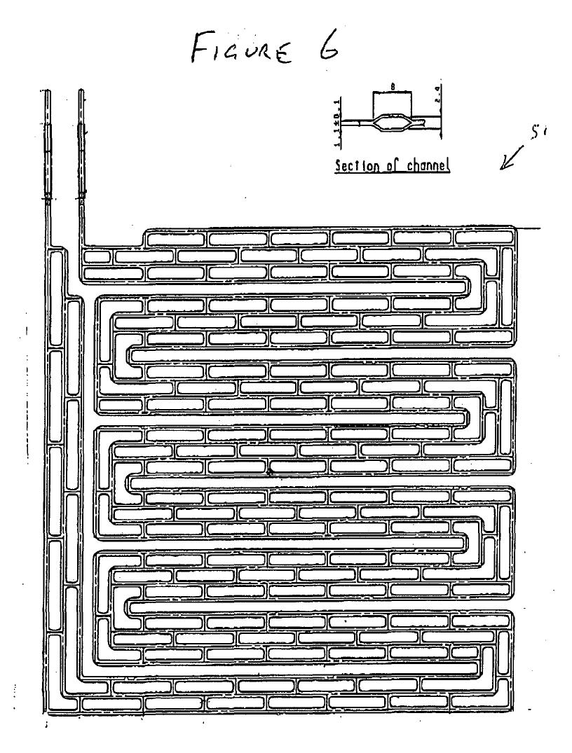

In the form shown in FIGS. 4 to 7B there is shown a eutectic system for use as the cooling system of the portable refrigeration container. The heat sink cold storage refrigeration assembly drawings show a mesh type housing enclosure 52 connected to the underside of the lid 40. A refrigeration plate 51 is slid along side rail 53 of the mesh type housing enclosure 52 and sandwiched between heat sink pads 54 of the Eutectic type within the mesh type housing enclosure 53.

Therefore the lower heat sink pads are located between lower side of the refrigeration plate face and the mesh type housing enclosure to allow direct cooling into the container volume. The upper heat sink pads are located on upper face of the refrigeration plate and there is an air cavity allows approximately 25 mm between upper face of upper heat sink pads 54 and container lid 40 lower mount face. This allows air flow over the upper heat sink pads and through the side of the mesh enclosure 52 into the container volume.

This eutectic type of heat sink pad is delivered flat when the container is transported in collapsible form (to minimize significant volume and weight) then needs to be submerged in a suitable fluid solution to absorb. The heat sink pads are then slid into the open face of the mesh type housing enclosure and sandwich the refrigeration plate heat exchanger with a good thermal contact. The mesh type housing enclosure can be manufactured from metal, polymer, composite or any other suitable material but includes perforations to allow cooling into the container volume.

Display Version

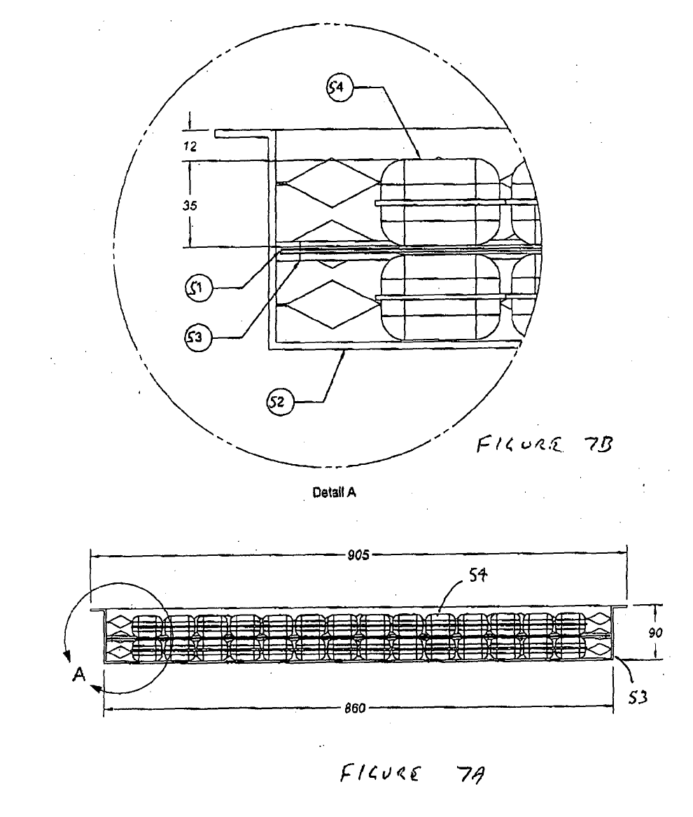

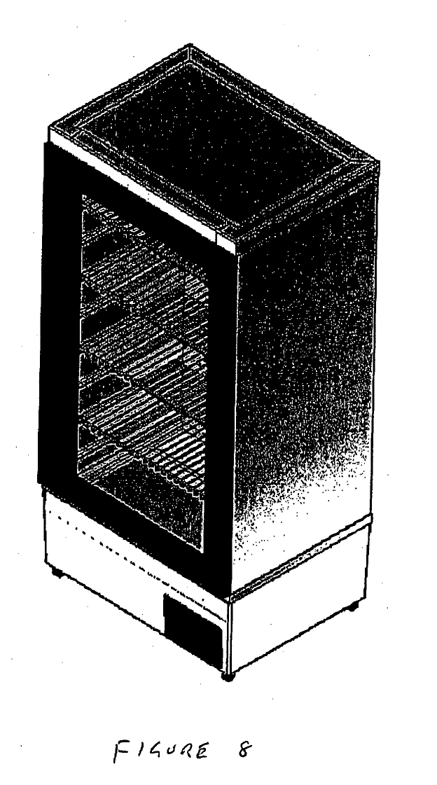

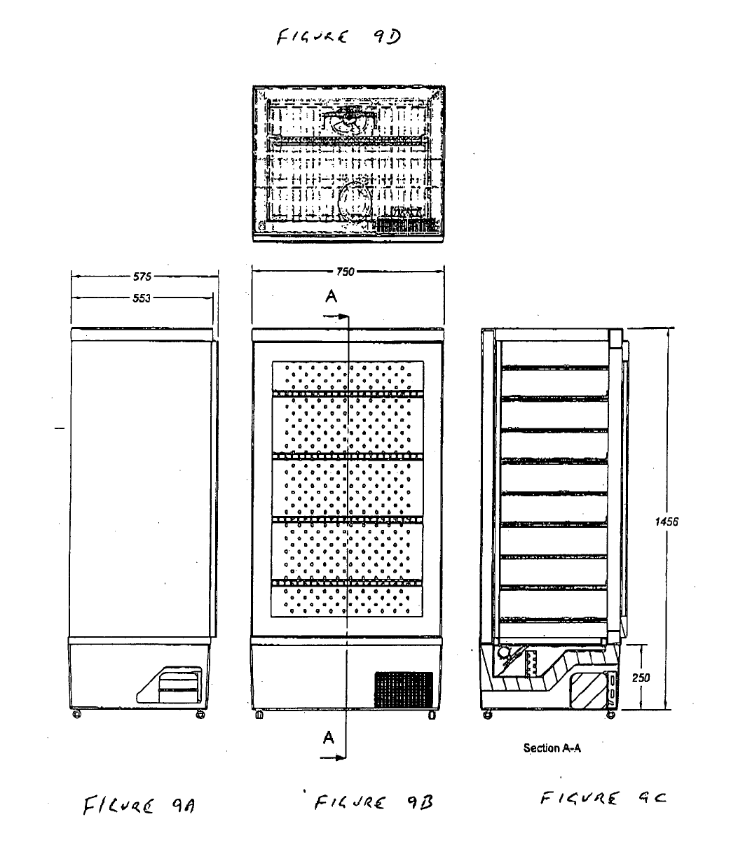

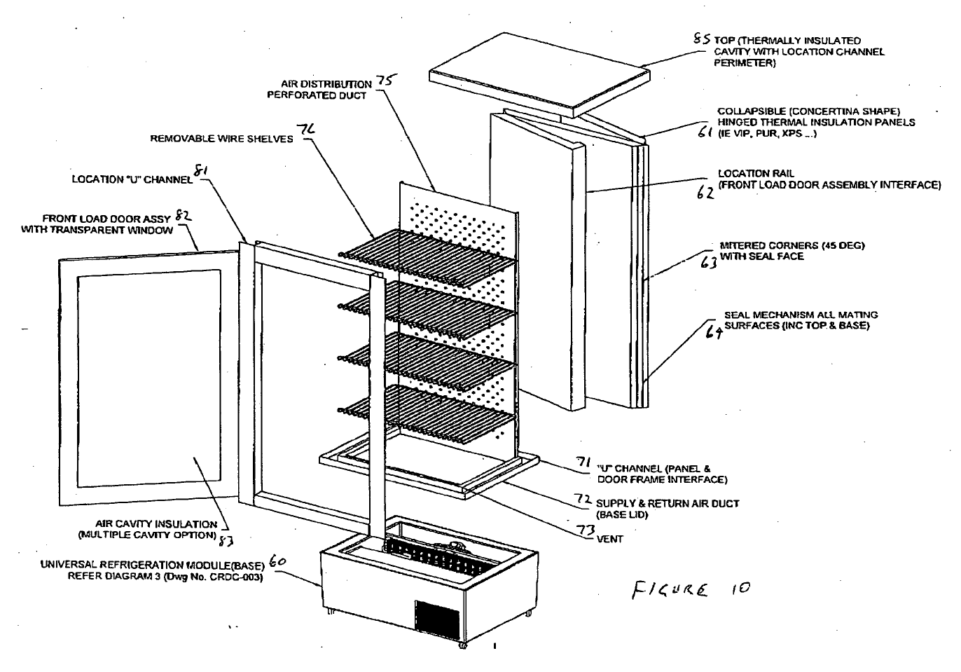

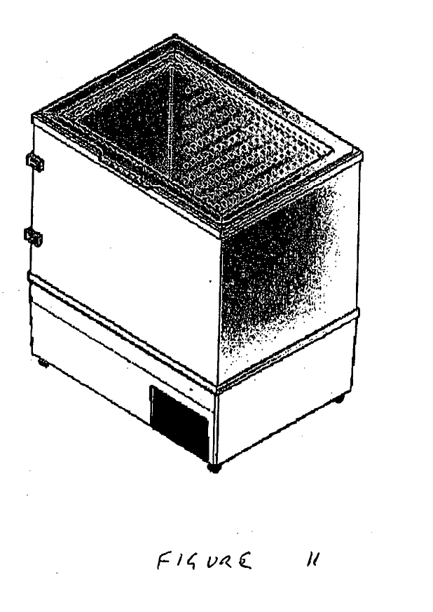

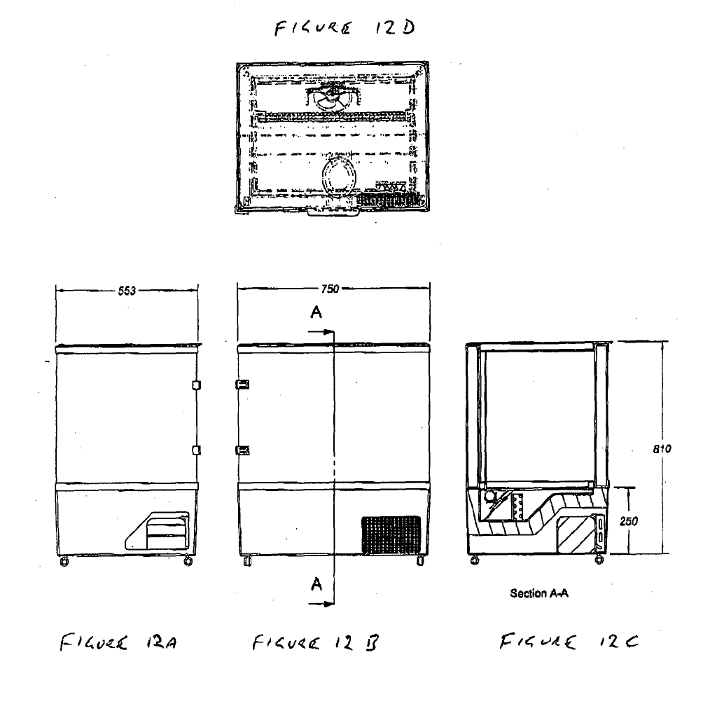

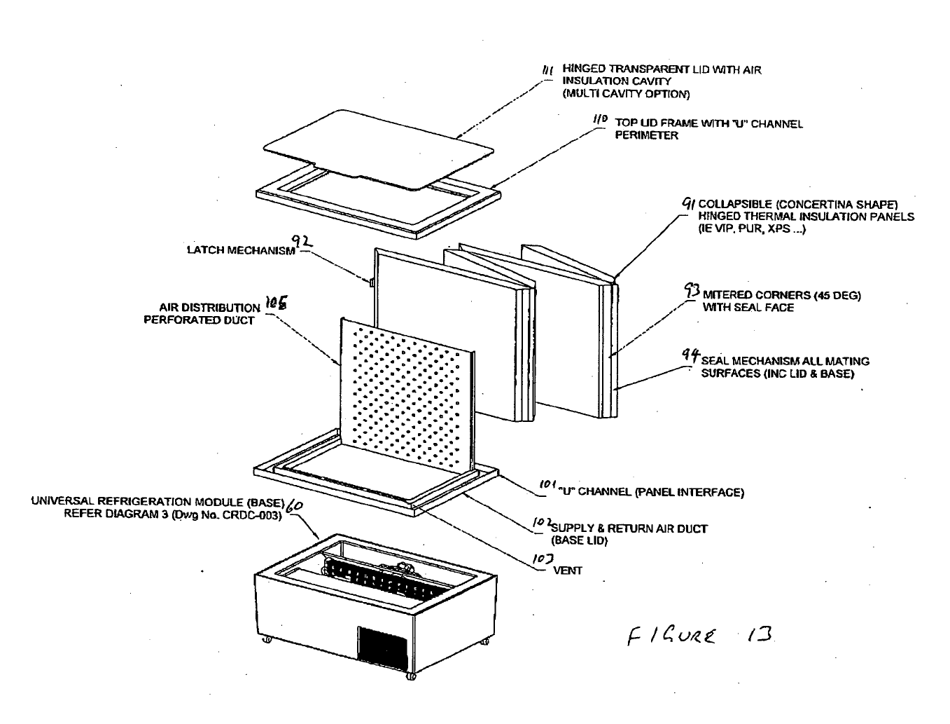

Referring to FIGS. 8 to 13 there is shown that this invention provides a collapsible refrigerated display case with universal base refrigeration module 60 which can be easily configured (assembled/disassembled) as either a front load or top load display case as required for the application. The assembly is capable of maintaining a medium refrigerated space temperature (above product freezing) but not limited. A low refrigerated space temperature with alternative refrigeration component specifications including a defrost mechanism is optional.

The front load form of the collapsible refrigerated display case assembly comprises a universal base refrigeration module, a U shaped collapsible side panel wall assembly, a base lid panel 72 having perimeter U channel 71 with vent 73, for mounting on the universal base refrigeration module 60 to form the base of the refrigerated container volume and on which a vertically oriented perforated panel duct 95 and the wall assembly 61 is mounted to define a container volume and a vertical airflow channel, and a lid assembly 85 for closing the top of the refrigerated container volume. Shelving comprising removable wire shelves 76 for fitting into the U shape wall assembly, and a front door assembly 82 with transparent window and a lid assembly 85 with thermally insulated cavity with location channel perimeter for closing the front and top of the refrigerated container volume.

The top load form of the collapsible refrigerated display case assembly comprises a universal base refrigeration module 60, a rectangular collapsible concertina hinged side panel wall assembly 91 of thermal insulation panels, a base lid panel 102 having perimeter U channel 101 with vent 103, for mounting on the universal base refrigeration module 60 to form the base of the refrigerated container volume and on which a vertically oriented perforated panel duct 105 and the wall assembly 91 is mounted to define a container volume and a vertical airflow channel, and a lid assembly 110 for closing the top of the refrigerated container volume and having hinged transparent lid with air insulation cavity 111.

The perforated duct panel in both configurations is mounted against the wall assembly & designed to fit around the supply air vent located on the base module, this forms an air duct (channel) between the inner wall face to allow uniform air distribution within the refrigerated space.

A typical application of the front load form involves the universal base refrigeration module being positioned on the required floor space. The collapsible side panel assembly (‘U’) is opened to form a right angular shape and located around the universal base refrigeration module interfacing seal mechanism perimeter. The perforated panel duct is positioned around the supply air vent.

Wire shelves are located on horizontal inner sidewall rails as required. The door assembly slides over vertical inner sidewall rails located at open face and the top and bottom door assembly cross members interface with the universal base refrigeration module and lid assembly interfacing seal mechanism perimeter allows the lid assembly to be positioned on the ‘U’ Shape collapsible side panel assembly interfacing with the seal mechanism perimeter. The assembly can then be secured with latch and strap type mechanisms.

The assembly is ready for use and can be loaded with product and the universal base refrigeration module can be plugged into a suitable power source.

A typical application of the top load form is for the universal base refrigeration module to be positioned on the required floor space. The collapsible side panel assembly (rectangular) is opened to form a rectangular shape and located around the universal base refrigeration module interfacing seal mechanism perimeter. A perforated panel duct is positioned around the supply air vent.

A lid assembly is positioned on the collapsible side panel assembly (rectangular) interfacing with the seal mechanism perimeter. The assembly can be secured with latch and strap type mechanisms.

The assembly is then able to be loaded with product (or stackable wire basket filled with product) and the universal base refrigeration module plugged into a suitable power source.

Principal of operation is that prior to refrigeration product loading the vapour compression refrigeration system is run off a suitable power source and the refrigerated space is preconditioned by the removal of heat down to the desired storage temperature. The refrigeration capacity of the universal base refrigeration module has sufficient capacity to cool product and maintain a desired storage temperature. An evaporator refrigeration coil sensor cycles in/out the vapour compression refrigeration system to maintain refrigeration cooling capacity.

In other embodiments of the invention the refrigeration cooling capacity can be maintained by other types of refrigeration system.

Methods of power source for the various versions can be from the mains power grid. However to maintain portability to remote areas or areas at least removed from mains power outlets, the power can be provided by stand alone systems such as those using solar (photovoltaic batteries), wind generation, hydropower generation. More preferably are the use of integrated systems using solar (photovoltaic batteries), fuel cells (Hydrogen), or battery cells, together with conventional power when available or for recharging.

Technical Details

Palletized Collapsible Refrigeration Container:

| Component: | Type: | Specification: |
|---|---|---|
| Battery | Nickel Metal | Voltage: 7.2 DC |
| Module | Hydride | Rated Capacity: 6.5 Ah |
| | | Output Density/Mass: 1300 W/kg |
| | | Energy Density/Mass: 46 Wh/kg |
| | | Size (Vol): 0.000593 m3 |
| | | No. of Modules: approx. 22 |
| Photovoltaic | Silicon Nitride | Rated: 80 W |
| Module | Multi Crystalline | Size (Vol): 0.0121 m3 |
| | Silicon Cells | |
| Refrigeration | Vapor | Refrigerant: 134a |
| Module | Compression | Voltage: 12˜42 DC |
| | Cycle | Cooling Capacity: 92 W @ −5′ C. |
| | | Evaporator Temperature (CECOMAF) |
| | | Compressor Displacement: 2.5 cc |
| | | Power Consumption (Inc Fan) |
| | | Approx. 80 W |
| Cold Storage | Eutectic Type | Absorbed Water Capacity: |
| Module | Flexible Packs | approx.18 kg/24 h |
| | | Latent Heat Capacity: approx. |
| | | 5656344 J |
| Thermal | Vacuum | Coefficient of Heat Transfer: |
| Insulation | | approx. 0.202 W/m2K |
| Panel | | |

Collapsible Refrigerated Display Case:

| Component: | Type: | Specification: |
|---|---|---|
| Refrigeration | Vapor | Refrigerant: 134a |
| Module | Compression | Voltage: 230 AC @ 50 Hz |
| | Cycle | Cooling Capacity: 268 W @ −5′ C. |
| | | Evaporator Temperature (ASHRAE) |
| | | Compressor Displacement: 5.59 cc |
| Thermal | Coreflute Inner & | Thermal Conductivity: |
| Insulation | Outer Sleeve | approx. 0.045 W/mK |
| Panel | with | |
| | Polyethylene | |
| | Foam Core | |
| Base | Polyurethane | Thermal Conductivity: |
| Insulation | Foam | approx. 0.022 W/mK |
| Cavity Fill | | |
| Transparent | Encapsulated | Thermal Conductivity: |
| Opening | Single Air Cavity | approx. 0.135 W/mK |
| Insulation | | |

1. (canceled)

2. (canceled)

3. (canceled)

4. A portable refrigeration container including
a shaped base forming a palletised thermally insulated base including a base seal mechanism and forklift fork receiving cavities allowing ready transportability;
a dismantlable wall assembly able to be mounted on the base to form a container volume, and engaging with the base sealing mechanism and including a thermally insulated hinge type collapsible concertina configuration of side panels with latch mechanism for defining a container volume therein;
a lid assembly able to cover the top of the container volume to provide an enclosed volume and including a seal mechanism for engaging with the wall assembly,
the portable refrigeration container further including a cooling system, incorporated in one or more of the base, sides or lid enabling maintaining of the enclosed container volume in a cooled state.

5. (canceled)

6. A portable refrigeration container according to claim 4 wherein the cooling system includes a eutectic cooling system having a eutectic plate able to be initially charged and used in location and capable of maintaining a refrigerated space temperature for an extended time without the need for any external power source.

7. (canceled)

8. A portable refrigeration container according to claim 6 wherein the eutectic refrigeration system includes a eutectic material which can be transported in flat light weight form and activated by immersion at remote site in activation liquid and charged by refrigeration means and used in location for extended time without the need for any external power source.

9. (canceled)

10. A portable refrigeration container according to claim 4 wherein the cooling system includes a powered thermodynamic refrigeration system wherein a cooling side of the system is mountable in communication with the inside of the container volume and the heat dissipation side of the system is mountable in communication with the outside of the container volume.

11. A portable refrigeration container according to claim 10 wherein the palletised thermally insulated base includes an integral battery compartment integrated within raised feet which allow forklift access for holding a battery and the integral cooling system, for cooling the container volume, and is powered at least partially by the battery allowing refrigeration for several days.

12. (canceled)

13. A portable refrigeration container according to claim 11 wherein the lid includes a solar panel for powering the cooling system or battery.

14. (canceled)

15. (canceled)

16. A portable refrigeration container according to claim 10 including the wall assembly having hinged thermally insulated side panels with mitered(45) corners including seal mechanism in a concertina configuration which are designed to collapse flat and open to form a rectangular shaped container volume, and the lid is a thermally insulated housing with integral channel seal mechanism located around the lower face perimeter.

17. (canceled)

18. A portable refrigeration container according to claim 10 having an integrated refrigeration housing located (moulded) as part of the external surface and contains the heat rejection side of the refrigeration module.

19. A portable refrigeration container according to claim 18 having a cold storage refrigeration coil mounted to the lid and having connectors for enabling the refrigeration cycle components to be in fluid communication with each other.

20. (canceled)

21. (canceled)

22. A portable refrigeration container according to claim 10 having super thermal insulation wall assembly construction such as vacuum insulation panels.

23. A collapsible refrigerated display case assembly including a base, a plurality of dismantlable walled assemblies able to be mounted on the base to form a refrigerated container volume wherein the base is a universal base refrigeration module which can be easily assembled or disassembled with one of the plurality of walled assemblies to form different configurations.

24. (canceled)

25. A collapsible refrigerated display case assembly according to claim 23 having the plurality of walled assemblies forming a top load display with the universal base refrigeration module, a rectangular collapsible side panel wall assembly, a perforated panel duct for mounting on the universal base refrigeration module to form the base of the refrigerated container volume and on which the wall assembly is mounted, and a lid assembly for closing the top of the refrigerated container volume.

26. A collapsible refrigerated display case assembly according to claim 23 having the plurality of walled assemblies forming a front load display comprising a universal base refrigeration module, a U shaped collapsible side panel wall assembly, perforated panel duct for mounting on the universal base refrigeration module to form the base of the refrigerated container volume and on which the wall assembly is mounted, shelving for fitting into the U shape wall assembly, and a door assembly and a lid assembly for closing the front and top of the refrigerated container volume and the front load door assembly frame comprises two vertical side members with ‘U’channels which interface (slide into) with the side panel vertical square edged rails and top and bottom cross members (rectangular) interface with the base and lid mating surfaces (channels) and a removable hinged sealed door with insulated transparent window (single/multiple air cavity) is attached to the frame to allow for product view and access and the lid is a thermally insulated housing with integral seal mechanism located around the lower face perimeter (channel).

27. A collapsible refrigerated display case assembly according to claim 26 wherein in the front load display case configuration the universal base refrigeration module is partitioned into two thermally insulated zones-high temperature for heat dissipation and low temperature for cooling effect-with airflow and ventilation paths and the base assembly open face is sealed by a lid having an integral seal mechanism located around the upper face perimeter and including integrated ducts/vents for return and supply of air to the universal base refrigeration module.

28. A collapsible refrigerated display case assembly according to claim 23 having the base housing a vapour compression refrigeration system comprising the following components, in a high temperature zone: a compressor, a condensate drain tray with coil (to contain/evaporate water condensate and desuperheat compressor discharge vapour), a heat rejection assembly (condenser coil with fan), a filter drier, and a refrigerant control mechanism; and comprising in a low temperature zone: a heat sink assembly (evaporator coil with fan), accumulator and temperature control and wherein in assembled form all refrigeration cycle components are in fluid communication with each other via plumbing.

29. A collapsible refrigerated display case assembly according to claim 23 wherein the wall assembly includes hinged thermally insulated side panels (i.e. fabricated/moulded) with mitered (i.e. 45) corners including seal mechanism in a concertina configuration are designed to collapse and open to form a 90 angular (‘U’) shape, and the hinged thermally insulated side panels (i.e. fabricated/moulded) have mitered (i.e. 45) corners including seal mechanism in a concertina configuration are designed to collapse and open to form a rectangular shape and the horizontal top and bottom end surfaces interface and seal against the refrigeration base and lid mating surfaces (channels).

30. A collapsible refrigerated display case assembly according to claim to 23 having the horizontal top and bottom end surfaces interface and seal against the refrigeration base and lid mating surfaces (channels) and the inner side walls have several parallel rails designed to support removable product display shelving and the open face inner side wall edges each have vertical square edged rails designed to interface with the door assembly side channels and having a perforated panel duct is located around the discharge air vent and rear panel inner face which panel is designed to uniformly distribute refrigerated air.

31. (canceled)

32. (canceled)

33. (canceled)

34. A collapsible refrigerated display case assembly according to claim 25 wherein in the top load display case configuration the universal base refrigeration module (i.e. fabricated/moulded) is partitioned into two zones (high temperature and low temperature) with airflow and ventilation paths and thermally insulated between the two and the base assembly open face is sealed by a lid (i.e. fabricated/moulded) comprising an integral seal mechanism located around the upper face perimeter (channel) including integrated ducts/vents (return and supply air) and the base assembly houses a vapour compression refrigeration system comprising the following components, in the high temperature zone: a compressor, a condensate drain tray with coil (to contain/evaporate water condensate and de-superheat compressor discharge vapour), a heat rejection assembly (condenser coil with fan), a filter drier, a refrigerant control mechanism and in the low temperature zone: a heat sink assembly (evaporator coil with fan), accumulator and temperature control and the refrigeration cycle components are in fluid communication with each other (via plumbing).

35. (canceled)

36. (canceled)

37. A collapsible refrigerated display case assembly according to claim 34 wherein a perforated panel duct (i.e. fabricated/moulded) located around the discharge air vent and rear panel inner face is designed to uniformly distribute refrigerated air

38. A collapsible refrigerated display case assembly according to claim 37 wherein the top load lid housing (i.e. fabricated/moulded) with integral seal mechanism located around the lower face perimeter (channel) interface with the insulated side panels and a removable hinged sealed lid (i.e. fabricated/moulded) with insulated transparent window (single/multiple air cavity) is attached to the housing to allow for product view and access.

39. (canceled)

40. (canceled)
